(19) United States
(12) Patent Application Publication
(10) Pub. No.: US 2008/0256920 A1
(43) Pub. Date: Oct. 23, 2008

(54) Mower Conditioner Having Auger Flights Positioned Over a Cutter Bar to Effect Clearing Thereof

(76) Inventor: Aaron Yanke, Ashern (CA)

Correspondence Address: ADE & COMPANY INC., 2157 Henderson Highway, WINNIPEG, MB, R2G1P9, CA

(21) Appl. No.: 11/876,533

(22) Filed: Oct. 22, 2007

Related U.S. Application Data
(60) Provisional application No. 60/862,256, filed on Oct. 20, 2006.

(51) Int. Cl. A01D 34/412

(52) U.S. Cl. 56/157; 56/153

(57) ABSTRACT

A mower conditioner includes a cutter bar supported on its frame transverse to the forward working direction and conditioning tools, which may be either tines or conditioning rollers, supported on the frame to span a distance transverse to the forward working direction. Auger flights are supported on the frame beyond opposite ends of the distance traversing the forward working direction for rotation about respective axes also traversing the forward direction, the auger flights beyond one end of the distance spanned by the conditioning tools being pitched in a direction opposite the auger flights on the opposite end of the distance spanned by the conditioning tools to convey cut crop material toward the conditioning tools. The auger flights are driven in a direction upward and forward from a lowermost point on their rotational path and are positioned over the cutter bar to effect clearing of the cut crop material therefrom.

This application claims the benefit under 35 U.S.C. 119(e) of U.S. provisional application Ser. No. 60/862,256, filed Oct. 20, 2007.

This invention relates to a mower conditioner for mowing and conditioning crop material, and more particularly to a mower conditioner using auger flighting to clear its cutter bar.

### BACKGROUND OF THE INVENTION

Conventional mower conditioners are machines that feature a cutter bar supported close to the ground to cut the stem of a crop and a conditioning assembly supported rearward of the cutter bar to condition the cut material. Crop conditioning involves creating breaks in the surface of the crop material, for example by kinking or crimping the stems, to encourage the escape of moisture from the material for a reduced drying time.

Conventional mower conditioners using sickle type cutter bars rely on a reel construction traversing the front of the machine parallel to the cutter bar to convey cut crop material rearward therepast toward the conditioner. The reel includes a number of elongate bats parallel to the cutter bar supported for rotation about the reel axis, each bat supporting a plurality of fingers from it at spaced positions therealong.

Conventional mower conditioners using rotary disc type cutter bars rely on the rotation of the disc cutters to propel the cut crop material rearward toward the conditioner.

Mower conditioners conventionally use either an impeller or roller based construction to condition cut crop materials.

In a conventional roller based construction, an auger disposed parallel to and rearward of the cutter bar has flights that are oppositely pitched on opposite sides of the longitudinal center of the auger. The auger extends the full length of the cutter bar such that material cut by the cutter bar is conveyed toward the center of the machine by the rotating auger. Reward of a central portion of the auger is a pair of rollers supported for counter-rotation about vertically spaced axes through which the cut material is fed to a discharge chute and conditioned between the surfaces of the intermeshing rollers. Roller based mower conditioners may use either rotary disc or sickle type cutter bars.

In roller conditioner and rotary disc cutter combinations, it is known to eliminate the auger and instead have all the disc cutters rotate toward the center of the machine to encourage crop material to flow inward toward the rollers at the center of the machine. To increase the effectiveness of crop movement by the disc cutters, it is known to add paddles or raised portions to the discs to establish vertical surfaces for pushing against the cut crop material. However, due to the high rotational speed of the disc cutters, even with these surfaces, movement of cut crop material rearward and toward the center of the machine may not be fast enough to avoid repeat cuts to a piece of severed crop material, resulting in a mulching effect on the crop.

In a conventional impeller based construction, a rotor disposed rearward and parallel to a rotary disc cutter bar has a plurality of tines or flails spaced over its periphery. The tines extend radially outward from the periphery during rotation of the rotor such that contact between the moving tines and the cut material conveys the material rearward while breaking up the material's surface. Contact of the material with a hood or conditioning plate disposed above the impeller intensifies the conditioning. Once again, the conveying effect of the rotating disc cutters on the crop material may not be sufficient to avoid mulching of the crop material.

U.S. Pat. No. 4,739,609 to Meier et al. teaches a mower conditioner that features a conditioner shaft having left and right pitched auger flights with conditioning tools secured along their outer edges. The oppositely pitched auger flights join at the longitudinal center of the shaft to direct cut material into a single narrow swath. The auger is relied upon for conveyance of cut crop material toward the center of the machine, but compared to an auger-equipped roller conditioning construction where the roller conditioner and auger conveyor must each be driven for rotation, this arrangement requires only the driven rotation of a single unit capable of both conditioning the material and conveying it toward the center of the machine.

However, this arrangement may not be capable of producing the same narrow swath when the length of the cutter and conditioner are increased to improve the pass width of the machine, as the increased distance over which the material is to be conveyed by the auger flights to the discharge chute may not be covered before the material is carried rearward by the conditioning tools. This may lead to material being discharged outside the swath or to a buildup of material beneath the hood which may become entangled about the shaft of the conditioner.

Furthermore, although the auger flights move the crop material toward the center of the machine to produce a narrow swath, the disc cutters are still relied upon to convey the cut material reward to the conditioner/auger, which as described above may result in a mulching action caused by repeated cutting of the crop material before clearing the cutter bar.

### SUMMARY OF THE INVENTION

According to a first aspect of the invention there is provided a device for mowing and conditioning crop material, the device comprising:

a frame supported for motion in a forward working direction;

a cutter bar supported on the frame transverse to the forward working direction;

conditioning tools supported on the frame to span a distance transverse to the forward working direction;

auger flights supported on the frame beyond opposite ends of the transverse distance spanned by the conditioning tools for rotation about respective axes transverse to the forward direction, the auger flights beyond one end of the transverse distance spanned by the conditioning tools being pitched in a direction opposite the auger flights on the opposite end of the transverse distance spanned by the conditioning tools to convey cut crop material toward the conditioning tools; and

a drive system linked to the cutter bar to drive a cutting action thereof, to the conditioning tools to drive a conditioning action thereof and to the auger flights to drive rotation thereof in a direction upward and forward from a lowermost point on a rotational path of the auger flights;

the auger flights being positioned over the cutter bar to effect clearing of the cut crop material therefrom.

The positioning of oppositely pitched auger flights on opposite sides of the conditioning tools directly above the cutter bar not only acts to convey the cut crop material toward the center of the machine but also acts to clear the freshly cut material from the cutter bar, thereby eliminating the need for a reel assembly when the cutter bar is a sickle bar and reducing the occurrence of mulching or repeated cutting when the cutter bar is a rotary disc cutter bar.

The auger flights beyond the one end may be defined by a first auger with the auger flights beyond the opposite end are defined by a second auger distinct from the first auger. In this instance, the conditioning tools may be supported between the opposite ends of the transverse distance on unflighted portions of the first and second augers, which may be interconnected at their unflighted portions for rotation together.

Alternatively, the auger flights beyond both ends may be defined by a common auger having an unflighted central portion on which the conditioning tools are supported.

The securing of the conditioning tools to the periphery of the rotor, which may be thought of as the auger drum or shaft, between the oppositely pitched auger flights allows the conveying of crop material cut by the cutter bar toward the center of the machine by the auger flights without interference of the material's flow path by the conditioning tools. This helps prevent buildup within the machine and promotes a cleanly formed swath, even when the cutting width of the machine is significantly greater than the width of the desired swath. In other words, having the conditioning tools disposed over only a portion of the machine's cutting width means that crop material will only be fed rearward along that portion, allowing formation of a clean well-defined narrow swath.

The conditioning tools may comprise a plurality of tines supported on a periphery of a rotor supported on the frame for rotation about an axis transverse to the forward working direction. In this instance, preferably there is provided a hood supported on the frame, the hood comprising a movable portion disposed above the conditioning tools and selectively movable upward and downward relative thereto. The hood may further comprise two fixed sections disposed above the auger flights on opposite sides of the movable section, the movable section being selectively movable upward and downward relative to the two fixed sections.

Alternatively, the conditioning tools may comprise conditioning rollers supported for rotation about vertically spaced axes transverse to the forward working direction.

The conditioning tools may be supported rearward of the auger flights.

The cutter bar may comprise a sickle bar cutter over which the auger flights are positioned to effect clearing of the cut crop material from the sickle bar cutter.

Alternatively, the cutter bar may comprise a rotary disc cutter bar over which the auger flights are positioned to effect clearing of the cut crop material from the rotary disc cutter bar.

There may be provided at least one blocker supported on the frame and positioned proximate the auger flights to limit wrapping of the cut crop about the axes under rotation of the auger flights. In this instance, preferably each blocker is positioned forward of and above at least one of the axes about which the auger flights rotate, the at least one blocker preferably comprising two blockers each positioned to extend along the axis about which the auger flights beyond a respective one of the opposite ends rotates.

Preferably the axes about which the flights rotate are situated over the cutter bar.

Preferably a forwardmost point on the rotational path of the auger flights is situated forward of the cutter bar.

Preferably a rearwardmost point on the rotational path of the auger flights is situated over the cutter bar.

Preferably the transverse distance spanned by the conditioning tools is parallel to the axes about which the auger flights rotate and to the cutter bar.

Preferably the distance spanned by the conditioning tools, the axes about which the auger flights rotate and the cutter bar are each perpendicular to the forward working direction.

### BRIEF DESCRIPTION OF THE DRAWINGS

In the accompanying drawings, which illustrate exemplary embodiments of the present invention:

FIG. 1 is a schematic right side elevational view of a first embodiment mower conditioner in accordance with the present invention.

FIG. 2 is a schematic left side elevational view of the first embodiment mower conditioner.

FIG. 3 is a schematic right side elevational view of a header of the first embodiment mower conditioner with the end walls of the header removed for illustration.

FIG. 4 is a schematic left side elevational view of the header of the first embodiment mower conditioner with the end walls removed for illustration.

FIG. 5 is a schematic partial overhead plan view of the first embodiment mower conditioner.

FIG. 6 is a schematic front elevational view of the first embodiment mower conditioner.

FIG. 7 is a schematic front elevational view of a rotor assembly of the first embodiment mower conditioner.

FIG. 8 is a schematic partially exploded close up view of a portion of the rotor assembly of the first embodiment mower conditioner illustrating mounting of conditioning tines on a rotor.

FIG. 9 is a schematic cross sectional view of the rotor assembly of the first embodiment mower conditioner as taken along line 9-9 of FIG. 7.

FIG. 10 is a schematic end elevational view of one of the tines of the first embodiment mower conditioner.

FIG. 11 is a schematic close up side elevational view of a center rotor support of the first embodiment mower conditioner.

FIG. 12 is a schematic close up front elevational view of a connection between the center rotor support and the rotor assembly illustrating part of an alternative embodiment drive system for the first embodiment mower conditioner.

FIG. 13 is a schematic front elevational view of a head of a second embodiment mower conditioner in accordance with the present invention.

FIG. 14 is a schematic front elevational view of a header of a third embodiment mower conditioner in accordance with the present invention.

FIG. 15 is a schematic side elevational view of a rotor assembly, blocker, cutter bar and conditioning rollers of the third embodiment mower conditioner.

FIG. 16 is a schematic overhead plan view of the header of the third embodiment mower conditioner.

### DETAILED DESCRIPTION

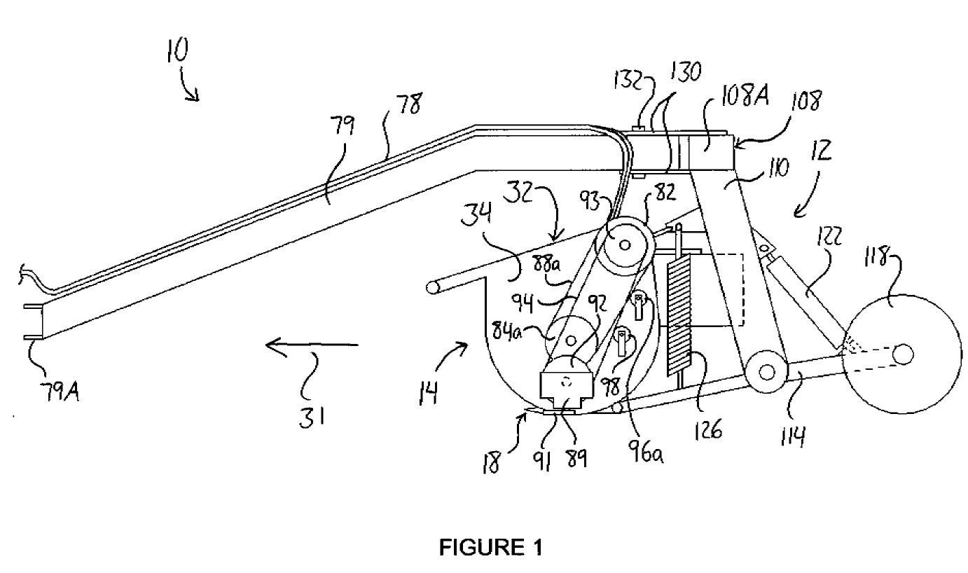

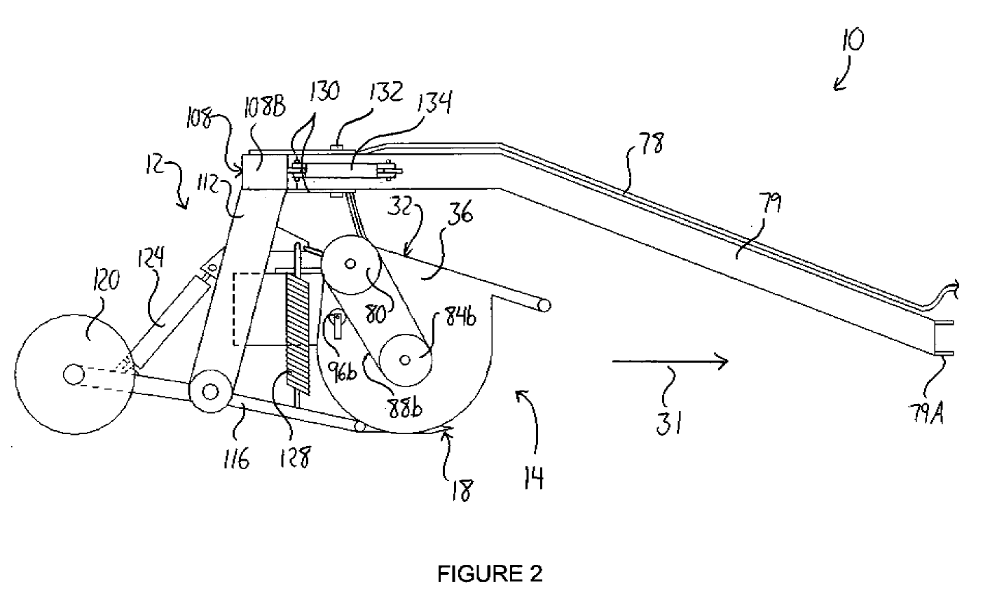

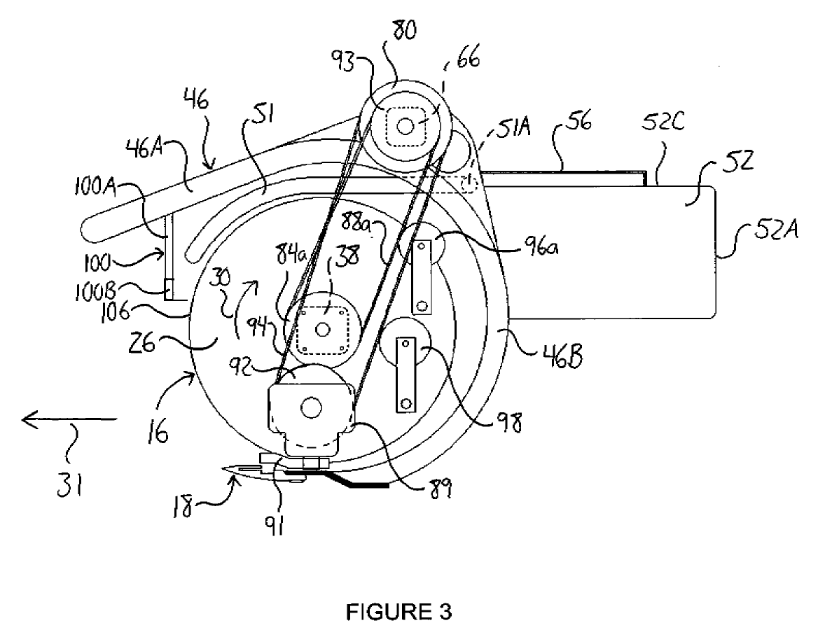

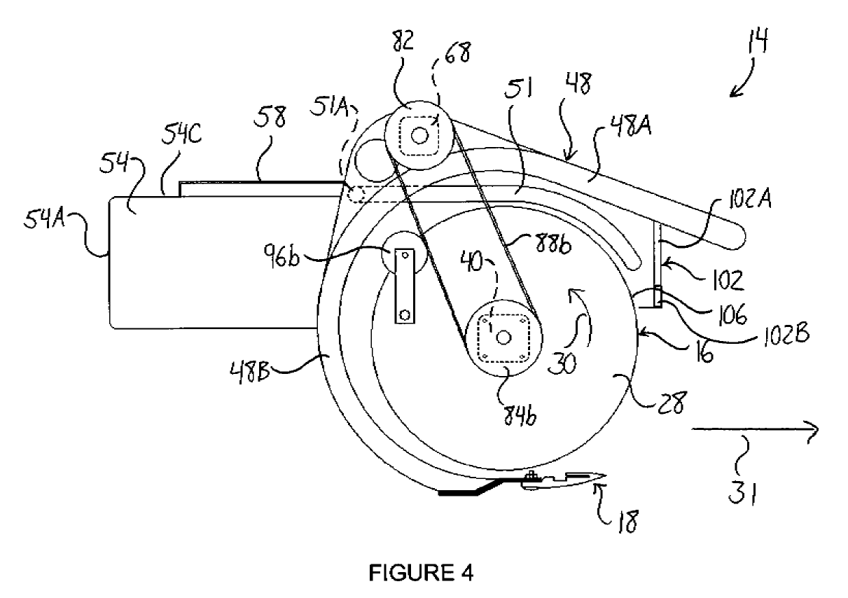

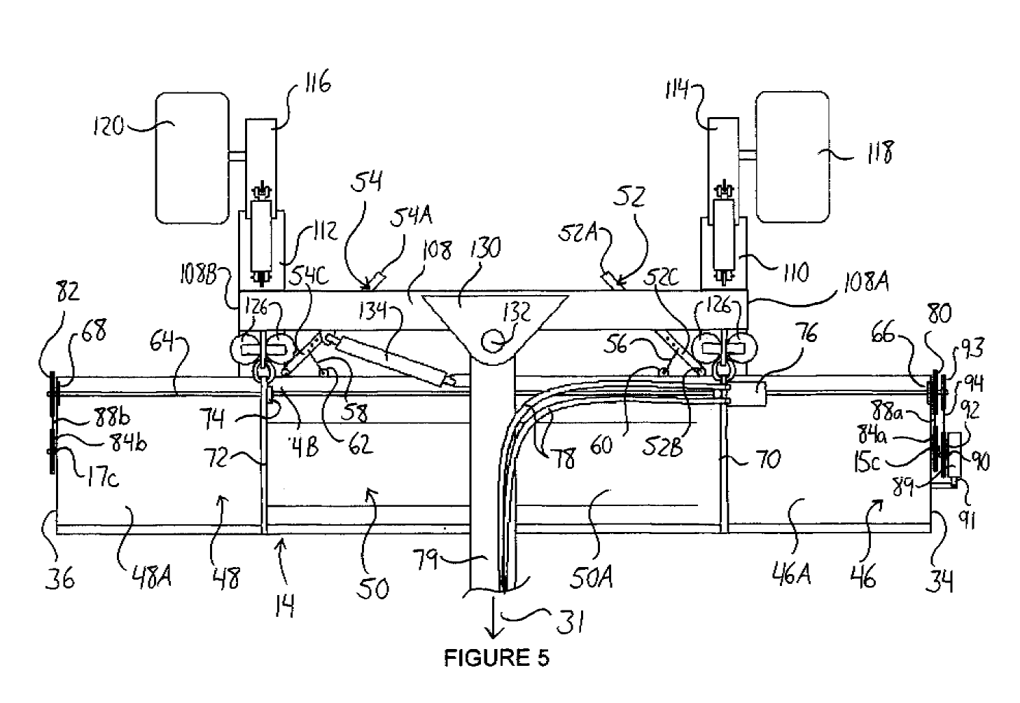

FIGS. 1 and 2 show a pull-type mower conditioner 10 in accordance with a first embodiment of the present invention. Just like a conventional pull-type unit, the mower conditioner 10 features a frame 12 carrying a header 14 that supports the cutting and conditioning components of the unit. As seen in FIGS. 3, 4 and 6, the header 14 features a rotor assembly 16 supported for rotation directly above a cutter bar 18, which is of the sickle bar type in the first embodiment. The rotor assembly 16 includes two separate rotors 15, 17 mounted end-to-end to extend across the machine with a plurality of conditioning tools 20 in the form of tines secured to the periphery of the two rotors 15, 17 over a fractional length of each proximate their adjacent ends 15a, 17a near the center of the header 14. On opposite sides of the conditioning tools 20, in other words on portions of the two rotors outward from the central tool-supporting portions, there are auger flights 26, 28 pitched in opposite directions to move material cut by the cutter bar 18 near the outer ends of the header toward the conditioning tools 20 near the center of the machine when the rotors are driven for rotation in the direction indicated by arrow 30 in FIGS. 3 and 4. This rotational direction is indicative of the auger flighting moving upward and forward from a lowermost point in its rotational path, forward referring to the working direction in which the mower conditioner is pulled during use, as indicated by arrow 31 in the Figures.

Of course crop material cut by the cutter bar 18 directly in front of the unflighted tool-supporting portions 15b, 17b of the two rotors 15, 17 near their adjacent ends 15a, 17a will be engaged by the conditioning tools 20 immediately, that is without having to be conveyed inward from outer end regions of the header 14 by the auger flights 26, 28. Positioned directly over the cutter bar 18, with a forwardmost point of the rotational path of the auger flighting's outer edge or periphery located forward of the cutter bar, illustrated as forward of the cutter bar's rear and forward limits and its center along the forward working direction, the rotor assembly 16 will thus carry crop material severed by the cutter bar immediately away from the location at which it was cut, either laterally (i.e. in a direction traverse to the forward working direction 31) inward toward the center of the machine or rearward over the rotors 15, 17 depending on where the material is cut along the cutter bar 18. Having the same rotor assembly 16 define the conditioner and a conveyor for moving the cut crop material inward eliminates the need for two driven components to perform these two tasks, and the positioning of the rotor assembly 16 directly over the cutter bar 18 eliminates the need for a rotating reel assembly conventionally required to clear cut crop material from the cutter bar 18.

A hood assembly 32 houses the rotor assembly 16 and cutter bar 18 and guides the flow of cut crop material through the mower conditioner. End walls 34, 36 of the hood assembly on opposite sides of the mower conditioner support bearings 38, 40 on their outer surfaces which support outer ends 15c, 17c of the two rotors 15, 17 and may be flanged bearings releasably fastened to the end walls, for example by bolts, to facilitate removal of the rotor assembly for service, repair or replacement. Between the end walls 34, 36 the hood assembly 32 features two side sections 46, 48, each of which aligns along the length of the header, or the width of the machine, with a flighted portion 15d, 17d of a respective one of the two rotors 15, 17 along the length thereof, and a central section 50 aligned with the unflighted tool-equipped portions 15b, 17b of the rotors along the length thereof.

The side sections 46, 48 feature top panels 46A, 48A disposed above the auger flights 26, 28 in close proximately thereto and extending forward therefrom. From the top panels 46A, 48A the side sections 46, 48 continue rearward, then downward and then forward concentrically curving about the auger flights 26, 28 thereby forming curved rear panels 46B, 48B. Connected to the end walls 34, 36 the side sections 46, 48 thereby close off the flighted portions 15d, 17d of the rotors 15, 17, outward from the unflighted central portions 15b, 17b with the conditioning tools, from above, from behind, from below and from the ends of the header 14. Thus, when crop material is cut near the ground by the cutter bar 18 at one of the side sections and becomes lodged between adjacent auger flights for conveyance toward the conditioning tools 20, exit of the material from the side section 46, 48 in any other direction is prevented.

The central section 50 of the hood assembly 32 is similar to the side sections, featuring a top panel 50A covering the central unflighted portions 15b, 17b of the rotors 15, 17 and the conditioning tools 20 thereon from above, but is open rearward of the rotor assembly 16 to allow discharge of the crop material. As shown in FIGS. 3 and 4, a conditioning plate 51 is supported beneath the top panel 50A and is mounted for pivoting about a horizontal axis along the plate's rear edge 51A, parallel to, rearward of and above the rotor assembly 16 to facilitate movement of the conditioning plate 51 upward and downward relative to the rotor assembly 16 and the upper panels of the hood assembly to allow selective adjustment of vertical spacing between the plate 51 and the and the outer tips of the conditioning tools 20 extending radially from the rotors 15, 17. The conditioning plate 51 extends horizontally forward from its pivotal mounting at its rear edge 51A to a point over the uppermost point in the rotational path of the conditioning tool tips about the rotors' rotational axes, from which the conditioning plate 51 then curves downward about these coinciding parallel axes toward a the front of the header 14. In the first embodiment, the tines defining the conditioning tools 20 are of a free-hanging variety, but it will be appreciated by those of skill in the art that fixed tines may also be used. Each tine 20 is secured to the one of the rotors 15, 17 for pivotal motion about an axis parallel to the rotor's rotational longitudinal center axis so that it hangs from or rests upon the rotor shaft or drum, depending on its circumferential position therabout, when the shaft or drum is stationary and extends radially from the shaft or drum during its rotation. It should therefore be appreciated that this adjustable spacing between the conditioning tool tips and the top panel 50A of the central hood section 50 refers to spacing during rotation of the shaft when the conditioning tool tips are at their maximum radial extent. This adjustability of the conditioning plate 51 allows for a degree of control over the conditioning process, as contact of the crop material with the plate 51 as it is carried rearward by the conditioning tools under rotation of the shaft contributes to conditioning of the material.

The center section 50 of the hood assembly 32 does not feature a complete rear panel, but instead is open at its rearmost end to allow discharge of cut and conditioned material from the header 14. Vertically oriented guide panels 52, 54 are supported on the rear of the header on opposite sides of the opening in the rear of the hood assembly's central section 50 to extend rearward therefrom, horizontally converging rearwardly away from the central section 50. The region between the guide panels 52, 54 defines a discharge channel having its wider end in communication with the open rear end of the central section 50 of the hood assembly 32. An opposite end of the channel marked by the distal ends 52A, 54A of the guide panels 52, 54 defines the width of the swath or windrow of cut and conditioned material formed by the mower conditioner by the distance between these distal ends. The mounting ends 52B, 54B of the guide panels are pivotally supported for pivoting about generally vertical axes on the rear of the hood assembly 32 to allow adjustment of the angle at which each guide panel is situated relative to a rear end of the hood assembly to change the convergence angle of the panels, thereby facilitating adjustment of the swath size by moving the distal ends 52A, 54A of the guide panels closer together or farther apart across the crosswise center of the machine. Arms 56, 58 are each adapted for connection to the central section 50 of the hood at one end and to a respective one of the guide panels 52, 54 at the opposite end. In the illustrated embodiments, each arm has ends bent at right angles to a common side of a main shaft. First ends of the arms are received to project downward into vertical holes through horizontal lugs 60, 62 projecting rearward from the central portion 50 of the hood over the rear opening therein and the opposite ends being receivable in vertical bores provided in upper edges 52C, 54C of the guide panels. Each panel features a plurality of vertical bores spaced along the length of its upper edge such that the respective fixed-length arm holds the guide panel at a different angle depending on which bore its second end is received in. Rather than having a number of selectable anchor points spaced along one or both of the components to be connected by an arm, one fixed anchoring point on each component could instead be used, wherein changing the length of the arm, either by substitution of an arm of different length or by extension/retraction of an adjustable arm, would control the position of the guide panel about its pivotal axis.

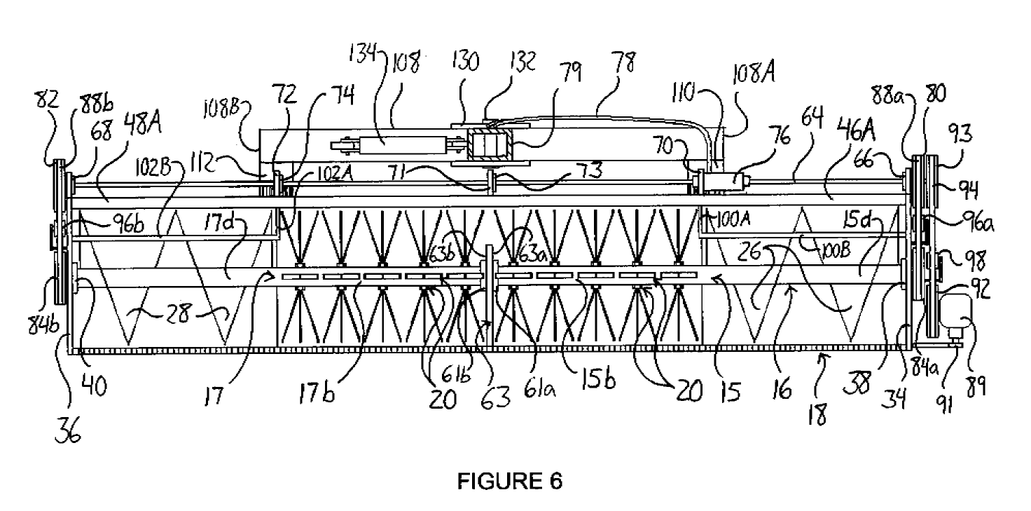

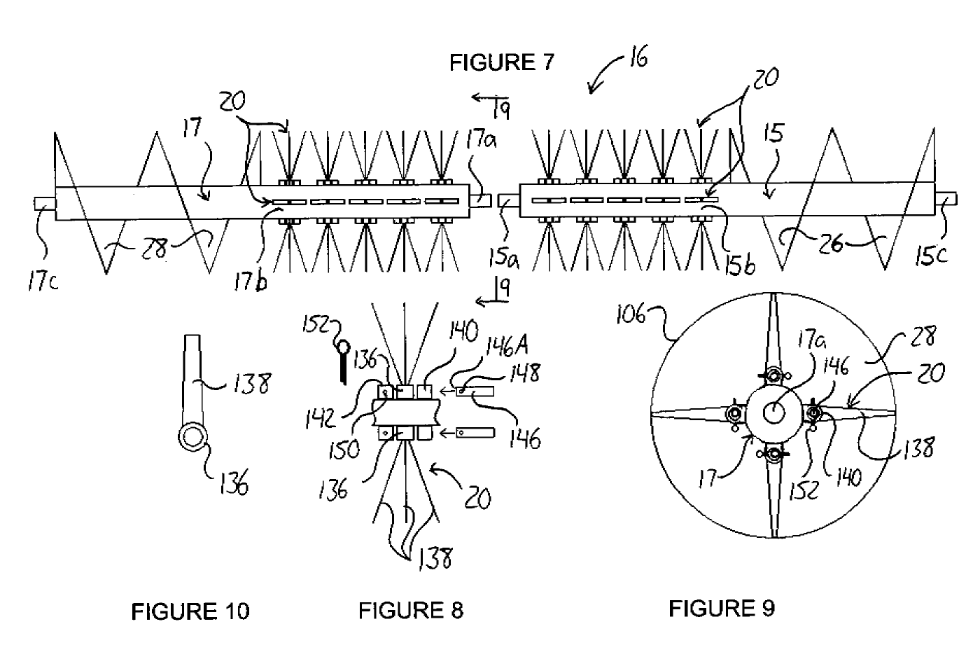

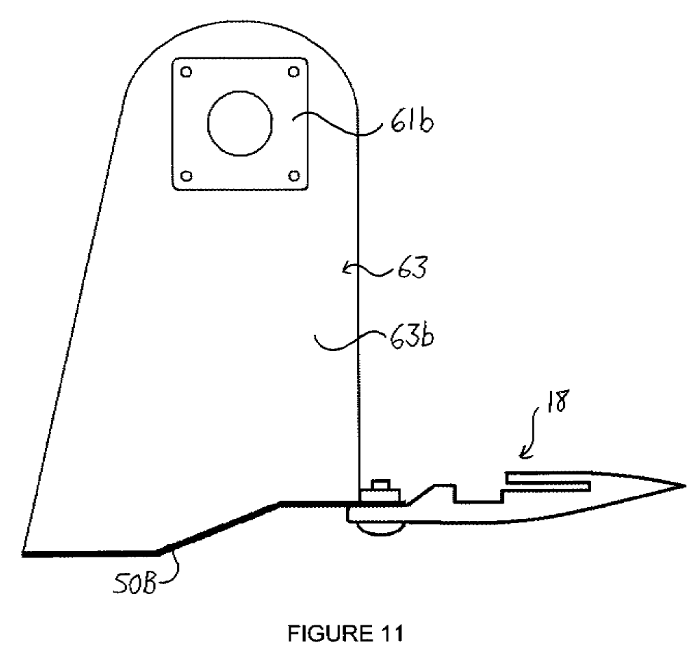

As can seen from FIGS. 6, 7 and 11, the inner adjacent ends 15a, 17a of the two rotors 15, 17 are supported at the center of the machine's width, as defined by the length of the elongate header 14, by a central support 63 projecting upward from a bottom panel 50B of the central section 50 of the hood assembly 32 extending between the side sections 46, 48 below the rotor assembly 16 and the opening at the rear of the central section 50 through which cut and conditioned crop material is discharged. On opposite sides 63a, 63b of the central support 63, that is on opposite sides of the central longitudinal axis of the machine extending along the forward working direction 31, there are provided bearings 61a, 61b, each receiving the inner end 15a, 17a of a respective one of the rotors 15, 17. Each rotor 15, 17 is thus supported for rotation between the central support 63 and a respective one of the ends walls 34, 36 similarly equipped with bearings 38, 40 on their inner surfaces facing the center of the machine.

The drive system for the mower conditioner includes a driveshaft 64 extending parallel to the cutter bar 18 and the rotor assembly 16 and supported above the top panels 46A, 48A and 50A of the hood assembly proximate a rear end thereof. The driveshaft 64 extends through the end walls 34, 36 of the hood assembly, which extend upward beyond the top panels thereof. Bearings 66, 68 are mounted on the end walls 34, 36 to support the driveshaft extending therethrough for rotation and again may be flanged bearings. Intermediate walls 70, 72 extend upward from the top panels 46A, 48A of the side sections 46, 48 between the end walls 34, 36 to further support the driveshaft 64. Intermediate wall 72 helps support the driveshaft passing through it by way of an additional bearing 74 mounted on it. The other intermediate wall 70 supports a hydraulic motor 76 from which the drive shaft 64 extends in opposite directions to the end walls 34, 36. The hydraulic motor 76 features a pair of supply and return hydraulic fluid lines 78 that extend along a tongue 79 of the mower conditioner frame 12 for connection to a suitable pumping source. A center wall 71 similarly projects upward from the top panel 50A of the central section 50 between the intermediate walls 70, 72 and features another bearing 73 through which the driveshaft 64 passes for further support thereof.

Pulleys 80, 82 are fixed to the driveshaft proximate opposite ends thereof outward of the end walls 34, 36 for rotation with the driveshaft under operation of the hydraulic motor 76. Respective pulleys 84a, 84b are fixed on the end portions 15C, 17C of the right and left rotors 15, 17 of the rotor assembly 16 outward past the end walls 34, 36 through which these end portions, supported by bearings 38, 40, pass. Endless flexible elements provided in the form of V-belts 88a, 88b are engaged about these pulleys, belt 88a extending about the right side pair of drive shaft and rotor pulleys 80a, 84a and belt 88b extending about the left side pair of drive shaft and rotor pulleys 80b, 84b, thereby rotating each of the right and left rotors 15, 17 of the rotor assembly 16 under driven rotation of the driveshaft 64 by the motor 76 to convey crop material cut at the outwardly positioned auger flighted portions 15d, 17d of the rotors toward the center of the machine with auger flights 26, 28 and to condition crop material so cut and conveyed, along with crop material at the central unflighted portions 15b, 17b of the rotors 15, 17, with the tines 20 and conditioning plate 51.

At one end of the header 14, a wobble box 89 has an input shaft 90 on which an additional pulley 92 is fixed and an output link 91 connected to the sickle cutter bar 18. Another endless flexible drive element is provided as V-belt 94 engaged about another pulley 93 fixed to the driveshaft 64 outside the hood assembly 32 past end wall 34 thereof between driveshaft pulley 80 the respective end of the driveshaft. V-belt 94 is engaged around this driveshaft pulley 93 and the input pulley 92 of the wobble box 89 which acts to convert the rotational motion from the pulleys into linear motion for driving the sickle cutter bar 18 so that rotation of the driveshaft 64 under operation of the hydraulic motor 76 will also rotate the input shaft 90 of the wobble box 89 to drive the cutter bar 18. Operational details of the mower conditioner cutter bars and the converter used to drive them from a rotational input are known, and thus not explained herein in further detail.

As shown in FIGS. 1 to 4 and 6, idler pulleys 96a, 96b and 98 may be pivotally mounted and biased on end walls 34, 36 in a known manner for movement about horizontal axes parallel to the rotational axes of the driveshaft, rotor and wobble box input shaft to take up slack and maintain tension in the V-belts 88a, 88b and 94.

As seen in FIGS. 3, 4 and 6, blocking bars 100, 102 are mounted to the underside of the top panels 46A, 48A of the side sections of the hood assembly 32 and each extend the full length of the respective side section parallel to the cutter bar. The blocking bars 100, 102 extend the length of the flighted portions 15d, 17d of the rotors 15, 17 in proximity to the periphery or outer edge 104, 106 of the auger flights 26, 28 above and forward of the rotational axes of the rotors 15, 17. The bars feature downward depending portions 100A, 102A secured to the top panels 46A, 48A and crossing portions 100B, 102B extending outward from the downward depending portions away from the center of the machine to the end walls 34, 36 of the hood assembly 32, to which they are also secured. When crop material cut by the cutter bar 18 enters the space between adjacent auger flights for movement toward the conditioning tools on the unflighted central portions 15b, 17b of the rotors 15, 17, the blocking bars act to help prevent wrapping of the material about the shaft by blocking upward and rearward movement of the material induced by rotation of the rotors and the flights secured thereto. This helps ensure that all material is conveyed to the unflighted central portions 15b, 17b of the rotors, where no blocking bar is present so that the conditioning tools can impact the material, carry it upward for further impact against the conditioning plate 51 and carry it rearward for discharge through the opening flanked by the guide panels 52, 54.

The frame 12 carrying the header 14 is adapted for connection to a towing vehicle (not shown) at a forwardmost end 79A of the tongue 79 which extends forward over the header. Suitable towing connections are well-known to those of skill in the art, and thus are not described in detail herein. At a rearmost end of the tongue opposite forwardmost end 79A, cross beam 108 extends to each side of the tongue 79, perpendicularly traverse to the forward working direction and parallel to the header and the rotors and cutter bar thereof. At the ends 108A, 108B of the cross beam 108, legs 110, 112 depend obliquely downward therefrom at a rearward angle to support beams 114, 116 extending along the mower conditioner rearward from the legs 110, 112 to support the wheels 118, 120 and forward from the legs to support the header 14. The beams 114, 116 are pivotal about horizontal axes at their connections to the legs 110, 112 so that, relative to the legs and cross beam, lowering the wheels will raise the header and raising the wheels will lower the header with respect to the legs.

Hydraulic cylinders 122, 124 are connected between lugs extending rearward from the legs 110, 112 upward from the beams 114, 116 and lugs extending upward from the beams rearward of the pivotal connections thereof to the legs, each cylinder being pivotal about horizontal axes at its end connections. Extension of these cylinders thus lowers the wheels 118, 120 and raises the header 14 with respect to the legs, thereby effectively lifting the header 14 up away from the ground surface to avoid damage to any of the header components during transport of the mower conditioner between mowing/conditioning operations. Springs 126, 128 are connected between lugs on the legs 110, 112 projecting forward therefrom upward from the beams 114, 116 and points on the beams forward of the pivotal connections thereof to the legs to pull upward on the header end of the beams, each spring being pivotal about horizontal axes at its end connections. This force pulling upward on the header end partially counteracts the weight of the header so that it will float, that is it will tend ride up over obstacles protruding from the ground rather than experience a potentially damaging collision. The header is mounted on the beams 114, 116 for pivoting about a horizontal axis thereacross and connectors between the lugs on the legs 110, 112, to which the springs are connected, are connected to the header proximate the top end thereof and are pivotal at each of their ends about a parallel horizontal axis. The frame connects to the header at the side sections 46, 48 thereof so that the guide panels 52, 54 are disposed between the connections.

The tongue 79 and cross beam 108 of the frame 12 are connected by flanges 130 secured atop and beneath the cross beam 108 and extending forward therefrom atop and beneath the tongue 79. A pivot pin 132 passes vertically through the flanges and tongue to allow horizontal pivoting of the tongue with respect to the cross beam along the plane thereof. A hydraulic cylinder 134 connected between the tongue and cross beam and pivotal about a vertical axis at each end can be extended and retracted to change the angle between the cross beam and tongue to change the position of the mower conditioner behind a towing vehicle. To avoid crowding within the drawings, hydraulic lines for connecting the hydraulic cylinders to a suitable hydraulic fluid pump are not shown as such connections are well known to those of skill in the art.

The length of a rotor assembly may be varied from one mower conditioner to another to suit particular requirements, just as the number, spacing and positioning of tines and the auger flight pitch distance may be varied from one rotor assembly to another. The rotor assembly of the first embodiment features forty tines 20 arranged, each rotor 15, 17 featuring four sets of tines equally spaced apart along the rotor and each set featuring four tines equally spaced about the rotor periphery, the tines of each set being circumferentially aligned about the rotor with the tines of the other sets. The tines extend a generally equal radial distance from the rotors as the equally sized auger flights 26, 28 during rotation of the rotor assembly.

The conditioning tools of the first embodiment rotor assembly are multi-fingered flails or tines, each including a hollow cylindrical base 136 of circular cross section having a plurality of fingers 138 extending outward from its periphery to a common side of the cylindrical base. The illustrated flails each have three fingers arranged with two on opposite sides of a center of the cylindrical base along the axis about which it closes and another projecting radially from the center of the base. The two fingers on opposite sides of the central finger are each tilted slightly out of a radial alignment with the cylindrical base to extend obliquely away from the central finger at equal angles thereto in opposite directions along the cylindrical base. Each finger 138 is tapered to narrow toward its distal tip opposite the cylindrical base in a plane perpendicularly traversing the axis of the cylindrical base, in which the flat finger lies.

On the periphery of the unflighted portions 15b, 17b of the rotors are provided lugs 140, 142 at opposite ends of each tine 20. Lug 140 features a cylindrical through-hole parallel to the rotational axis of the rotor and lug 142 features a cylindrical recess parallel to the rotational axis of the rotor and extending into, but not through, the lug 142 from the side thereof facing the other lug 140. The tine 20 is placed between the lugs 140, 142 to position the open-ended cylindrical base 136 such that its hollow interior 144 communicates, in concentric alignment, with the recess in lug 142 and the through-hole in lug 140. A first end 146A of a pin 146 is passed through the aligned through-hole and the hollow cylindrical base fully into the recess, which aligns a transverse through-hole 148 proximate the first end 146A of the pin with a second transverse through-hole 150 in lug 142 crossing perpendicularly through the cylindrical recess therein. A locking pin 152 is passed through the aligned through-holes to secure pin 146 in place by blocking withdrawal thereof from the recess, cylindrical base 136 of the flail and the first through-hole of lug 140. This secures the flail 20 between the lugs 140, 142 while allowing pivoting of the flail about the pin 146.

Other tine shapes and mounting arrangements known to those of skill in the art for use on various impeller-equipped mower conditioners may alternatively be used.

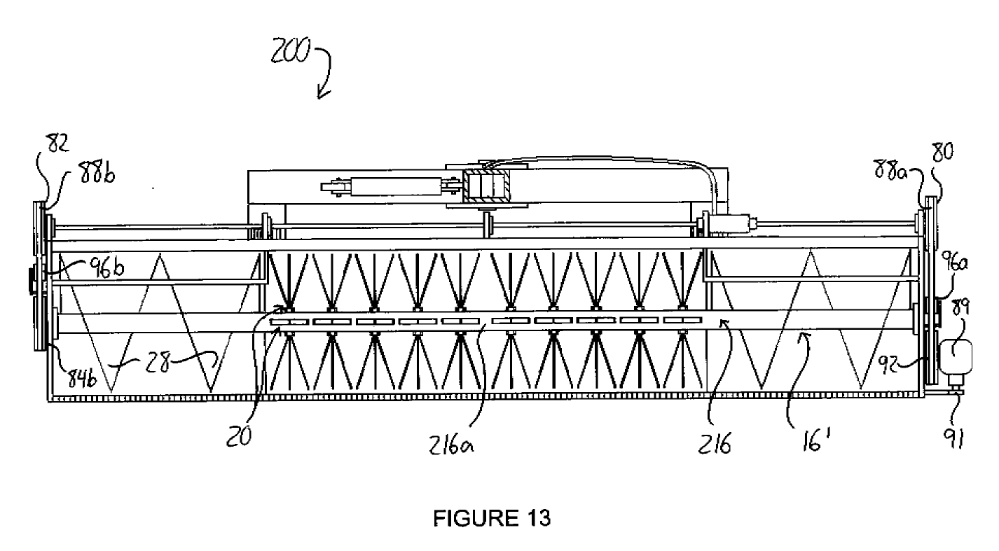

FIG. 13 shows a second embodiment mower conditioner 200 in which the two-rotor rotor assembly has been replaced with a single-rotor rotor assembly 16′. The central support 63 has accordingly been removed, but it will be appreciated that such a bearing equipped support could be provided with the single rotor passing therethrough for increased support. An unflighted central portion 216a of the single rotor 216 is equipped with tines 20 in the same manner as the adjacent unflighted rotor portions 15b, 17b at the center of the first embodiment machine. The oppositely pitched auger flights 26, 28 are provided on opposite sides of this conditioning tool equipped unflighted central portion 216a to convey material cut laterally outward therefrom toward the center of the machine for conditioning. With the single rotor 216, the rotor assembly is driven from only one end thereof, and so the auger assembly pulley 88a at the end of the header from which the cutter bar is driven in the first embodiment is eliminated, and so is the corresponding driveshaft pulley 80 and idler pulley 96a. The driveshaft 64 thus drives the wobble box 89 and cutter bar 18 at one end and the rotor assembly 16′ from the other. It should be appreciated that the rotor assembly and cutter bar may instead be driven from a single end of the header 14, allowing for shortening of the driveshaft, by instead eliminating the other rotor driving pulley set.

For wider mowing conditioners, for example sixteen feet or greater in width, aimed at having a large cut width to reduce the number of passes required to mow and condition a fixed field area, the first embodiment construction may be easier to produce due to the use of two shorter rotors compared to a single rotor, as a single rotor having a length generally equal to the combined length of two shorter rotors may be more difficult to balance for smooth rotation with little vibration. The first two embodiments both facilitate the use of a sickle type cutter bar with an impeller type arrangement not spanning the full width of the machine, as the auger flights ensure that cut crop material is moved toward the center of the machine for exposure to the impeller like section(s) of the rotor(s). At the same time, the need to include a reel assembly conventionally used to clear a sickle type cutter bar is eliminated. Conventionally impeller conditioning has been limited to use with rotary disc cutters, which are known to use more energy than sickle bar cutters.

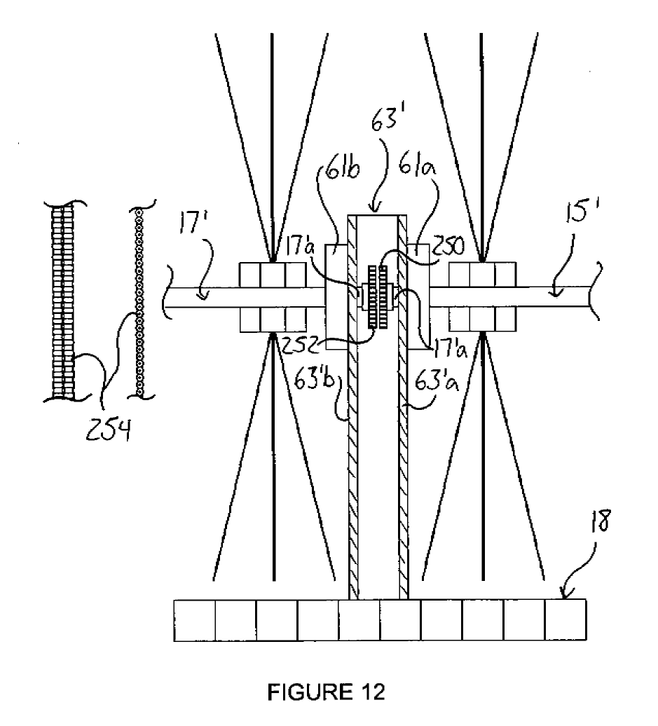

FIG. 12 illustrates the connection of two rotors 15′, 17′ to a center support 63′ in an alternate embodiment combining aspects of the two rotor structure of the first embodiment mower conditioner 10 with aspects of the one-sided rotor driving arrangement of the second embodiment mower conditioner 200. Here the center support 63′ features a pair of vertical plates 63′a and 63′b extending upward in a parallel fashion from the bottom of the central section of the hood, the two plates being spaced apart along the length of the header, or the width of the machine, to define a hollow space therebetween. Like in the first embodiment, bearings 61a and 61b are mounted on opposite sides of the center support 63′, here defined by outer surfaces of the plates 63′a, 63′b facing the end walls of the header's hood assembly. The end portions 15′a, 17′a of the rotors 15′, 17′ extending through the bearings 61a, 61b and the plates 63′a, 63′b into the space defined therebetween. Sprockets 250, 252 are mounted on the adjacent ends of the two rotors 15′, 17′ for rotation with the two parallel rotors about their shared rotational axis.

A double-chain endless loop 254, a commercially available product made up of two flexible endless chains interconnected side by side between corresponding links to flexibility in the resulting closed loop chain and shown partially in FIG. 12 in head on and side views from left to right, is fitted about the equally sized sprockets 250, 252 mounted concentrically and face to face at the adjacent ends of the rotors 15′, 17′ so that the links of each chain engage about the teeth of a respective sprocket. With the two rotors so connected, the rotor assembly as a whole can be driven for rotation from a single end of the header, for example in a driveshaft pulley arrangement such as that described for the single-rotor second embodiment. The endless double drive chain may allow for some give between the two connected rotors. Other ways of interconnecting two shafts, drums or rotors temporarily for later separation as desired are known to those of skill in the art, and may alternatively be applied.

It will be appreciated that similar bearing-equipped supporting arrangements could be used at be used at positions other than the longitudinal center of the header, or widthwise center of the machine, to allow division of the rotor assembly into a further number of separable parts without the need to provide additional links between the driveshaft of each part of the rotational rotor assembly. For example, the second embodiment rotor assembly 216 could be divided into three pieces: two augers and a tine-carrying impeller, with two intermediate supports of structure 63′ provided at the opposite ends of the hood assembly's center section. Each auger would be equipped with a sprocket at its center-most end for cooperation with one of two sprockets mounted on the opposite ends of the impeller.

Division of the rotor structure into smaller sections detachably mounted to intermediate supports provided at spaced locations along the header between the end walls thereof not only provides smaller, easier to balance impeller rotors and augers, but also allows for more affordable repair should one section be damaged, as the entire rotor assembly need not be replaced. Furthermore, such detachable sections can be removed from one machine and installed on another. From this, combined with the description below, it will be appreciated that an auger section described in the immediately preceding paragraph could be removed from the impeller-equipped rotor assembly and installed on a roller conditioner of type described below for the third embodiment. Such interchangeability reduces the cost and number of distinct parts needed to own and operate two different mower conditioners.

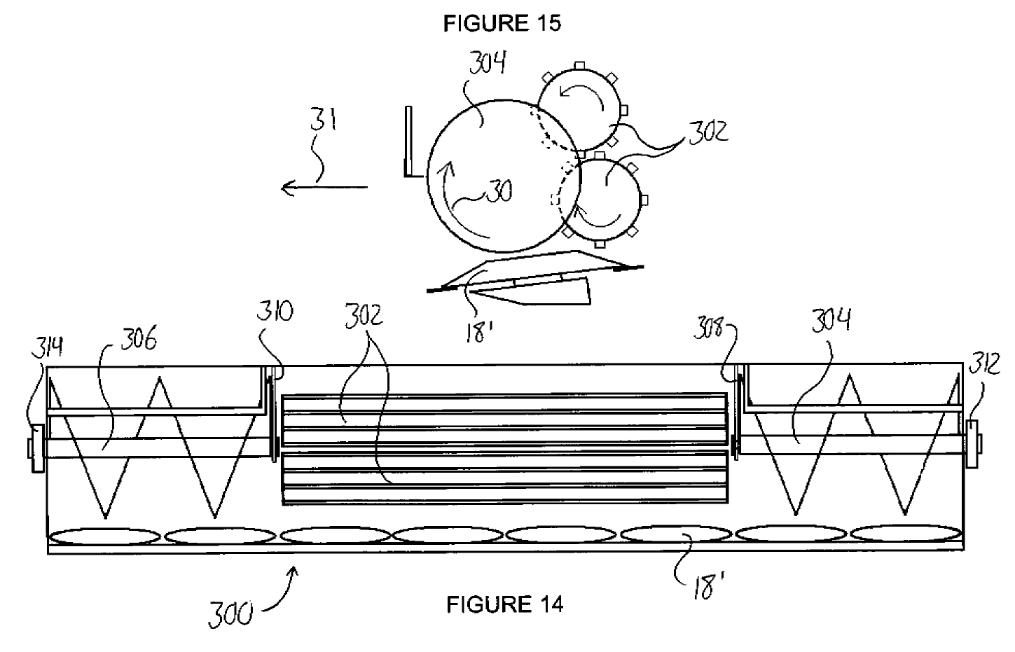

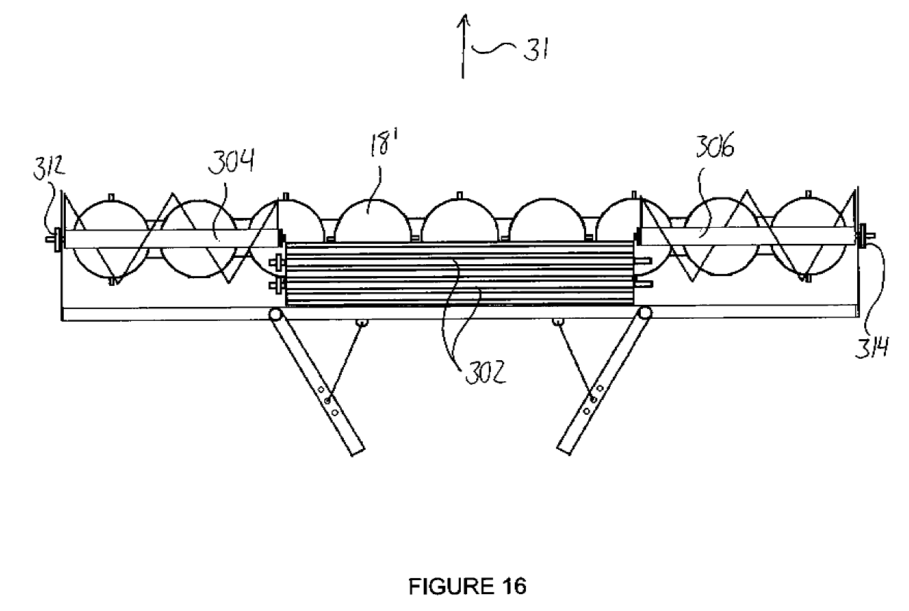

FIGS. 14 to 16 schematically illustrate a third embodiment mower conditioner header 300, which features a rotary disc cutter bar 18′. Compared to the first and second embodiments, the impeller-like conditioning arrangement found at the central portion of the rotor assembly has been removed, and replaced with a pair of conditioning rollers 302 supported for intermeshing counter-rotation about vertically spaced, horizontal parallel axes extending perpendicularly crosswise to the forward working direction of the machine to feed cut crop material rearward between them, as is well known in the art. At opposite ends these rollers 302, are augers 304, 306 equipped with auger flighting 26, 28 like that of the first two embodiments, arranged with the flights on the opposite sides of the conditioners centrally located along the machine's width pitched in opposite directions to convey material inward toward the widthwise center of the machine.

Like the auger flighting of the first two embodiments, the augers 304, 306 are positioned directly over the cutter bar 18′ to effect clearing thereof immediately upon cutting of crop material by the disc cutters by rotating in direction 30, forward and upward from a lowest point in the circular path of the auger flighting's outer edge or periphery. Relative to conventional disc cutter mower conditioners, the augers improve convergence of cut crop material from the ends of the header to the centrally mounted conditioning rollers 302 and, due to the immediate clearing of material from the cutting area, reduces the likelihood of mulching. In FIG. 15, the central rotational axes of the augers 304, 306 are positioned directly over the disc cutter bar 18′, specifically between the leading and trailing extents of the cutter bar in the forward working direction and forward of the cutter bar's center in the forward working direction, with the auger flights similarly positioned to fit entirely within the horizontal space between the leading and trailing extents of the cutter bar. The conditioning rollers 302 are supported rearward of the rotational axes of the augers 304, 306, with the narrowest gap between the conditioning rollers positioned just behind the rearwardmost point in the augers' rotational paths to ensure crop material from the augers is feed between the rollers for conditioning and rearward conveyance.

Like the rotors of the first embodiment, the augers 304, 306 have their outer ends supported by bearings mounted to the end walls of the hood assembly. Inner ends 304a, 306a of the augers 304, 306 situated just outward from the ends of the conditioning rollers 302 are supported by bearings mounted on supports 308, 310 depending downward from the top panels of the hood assembly. Pulleys 312, 314 mounted on the augers 304, 306 outside the hood past the end walls thereof are driven in the same way as the corresponding pulleys mounted to the outer ends of the rotors in the first embodiment to effect operation of the augers.

Each of the embodiments described above benefits from the positioning of oppositely pitched auger flighting disposed outwardly beyond opposite ends of a distance spanned by conditioning tools in a direction traversing the forward working direction of the mower conditioner, whether that distance is defined by tines spaced along the traversing direction or by conditioning rollers extending along the traversing direction.

Although the illustrated embodiments teach center-pivot pull-type mower conditioners for towing behind an agricultural vehicle and powering by the hydraulic system thereof, it should be appreciated that the teachings of these embodiments may be applied other types of mower conditioners. The frame and drive system used with the rotor assembly or header of the illustrated embodiments may be modified by those of skill in the art accordingly. For example, the arrangement of auger flighting over the cutter bar to effect clearing thereof an conveyance of cut crop material to the center of the machine may be applied to self-propelling mower conditioners or pull-type mower conditioners using a mechanical power take off shaft in place of the hydraulic system described above.

It should be appreciated that the rotational axes of the conditioning and conveying components need not necessarily be exactly parallel to the cutter bar and perpendicular to the forward working direction of the machine as illustrated and described for the detailed embodiments so long as they traverse the forward working direction, but that these arrangements facilitate a relatively simple construction can be produced, operated and maintained at relatively low cost. The first embodiment may be modified to support the impeller defining central tine-equipped portion separately from the auger flighted portions to further simplify the balancing of the rotational components and that the rotational axis of such an impeller may be shifted reward from that of each of the resulting augers while still having the same advantages of auger flighting strategically positioned over the cutter bar. Furthermore, the rotational axes of the two sets of auger flighting need not necessarily coincide or be parallel, but may be defined by a single auger extending fully across the header forward of the conditioner. The augers or rotors may use a hollow drum or solid shaft for a rotational body. The roller conditioner and auger combination may be used with a sickle bar cutter just as the tine conditioner and auger flighting combination may be used with a rotary disc cutter bar.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A device for mowing and conditioning crop material, the device comprising:
a frame supported for motion in a forward working direction;
a cutter bar supported on the frame transverse to the forward working direction;
conditioning tools supported on the frame to span a distance transverse to the forward working direction;
auger flights supported on the frame beyond opposite ends of the transverse distance spanned by the conditioning tools for rotation about respective axes transverse to the forward direction, the auger flights beyond one end of the transverse distance spanned by the conditioning tools being pitched in a direction opposite the auger flights on the opposite end of the transverse distance spanned by the conditioning tools to convey cut crop material toward the conditioning tools; and
a drive system linked to the cutter bar to drive a cutting action thereof, to the conditioning tools to drive a conditioning action thereof and to the auger flights to drive rotation thereof in a direction upward and forward from a lowermost point on a rotational path of the auger flights;
the auger flights being positioned over the cutter bar to effect clearing of the cut crop material therefrom.

2. The device according to claim 1 wherein the auger flights beyond the one end are defined by a first auger and the auger flights beyond the opposite end are defined by a second auger distinct from the first auger.

3. The device according to claim 2 wherein the conditioning tools are supported between the opposite ends of the transverse distance on unflighted portions of the first and second augers.

4. The device according to claim 3 wherein the first and second augers are interconnected at their unflighted portions for rotation together.

5. The device according to claim 1 wherein the auger flights beyond both ends are defined by a common auger having an unflighted central portion on which the conditioning tools are supported.

6. The device according to claim 1 wherein the conditioning tools are supported rearward of the auger flights.

7. The device according to claim 1 wherein the conditioning tools comprise a plurality of tines supported for rotation about an axis transverse to the forward working direction.

8. The device according to claim 7 further comprising a hood supported on the frame, the hood comprising a movable portion disposed above the conditioning tools and selectively movable upward and downward relative thereto.

9. The device according to claim 8 wherein the hood further comprises two fixed sections disposed above the auger flights on opposite sides of the movable section, the movable section being selectively movable upward and downward relative to the two fixed sections.

10. The device according to claim 1 wherein the conditioning tools comprises conditioning rollers supported for rotation about vertically spaced axes transverse to the forward working direction.

11. The device according to claim 1 wherein the cutter bar comprises a sickle bar cutter over which the auger flights are positioned to effect clearing of the cut crop material from the sickle bar cutter.

12. The device according to claim 1 wherein the cutter bar comprises a rotary disc cutter bar over which the auger flights are positioned to effect clearing of the cut crop material from the rotary disc cutter bar.

13. The device according to claim 1 further comprising at least one blocker supported on the frame and positioned proximate the auger flights to limit wrapping of the cut crop about the axes under rotation of the auger flights.

14. The device according to claim 13 wherein the at least one blocker comprises two blockers each positioned to extend along the axis about which the auger flights beyond a respective one of the opposite ends of the transverse distance spanned by the conditioning tools.

15. The device according to claim 13 wherein each blocker is positioned forward of and above at least one of the axes about which the auger flights rotate.

16. The device according to claim 12 wherein the axes about which the flights rotate are situated over the cutter bar.

17. The device according to claim 11 wherein a forwardmost point on the rotational path of the auger flights is situated forward of the cutter bar.

18. The device according to claim 12 wherein a rearwardmost point on the rotational path of the auger flights is situated over the cutter bar.

19. The device according to claim 1 wherein the transverse distance spanned by the conditioning tools is parallel to the axes about which the auger flights rotate and to the cutter bar.

20. The device according to claim 19 wherein the distance spanned by the conditioning tools, the axes about which the auger flights rotate and the cutter bar are each perpendicular to the forward working direction.
